(19) United States
(12) Patent Application Publication
(10) Pub. No.: US 2017/0124085 A1
(43) Pub. Date: May 4, 2017

(54) WEBSITE NAVIGATION PATH ANALYSIS

(71) Applicant: Haider Raza Khan, Bangalore (IN)

(72) Inventor: Haider Raza Khan, Bangalore (IN)

(21) Appl. No.: 14/932,903

(22) Filed: Nov. 4, 2015

(51) Int. Cl. G06F 17/30; G06N 99/00; G06N 7/00

(52) U.S. Cl. CPC G06F 17/3053; G06F 17/30598; G06N 7/005; G06N 99/005; G06F 17/30876

(57) ABSTRACT

A method and a system for website navigation path analysis are disclosed. The system comprises of a processor; a non-transitory computer-readable storage medium coupled to the processor. The processor executes a plurality of the modules/subsystems stored in the storage medium such as a data categorizing module for categorizing web pages of the website into one or more groups of web pages based on the domain knowledge and functional similarities between the web pages; a score assigning module for calculating an index score, casual score, base line score and engagement score for web page elements and categorized web page pair; a statistical model to be trained with the scores and weight calculated by the score assigning module, and an analyzing module for determining which web pages and transitions correspond to engagement and decision making based on the trained statistical model.

### FIELD OF INVENTION

The present invention relates to a system and method for discovering model for the website navigation process used by visitors to the website. More specifically, the present invention is related to a method for determining that how visitors traverse and interact with the website based on their needs and elements/stimulus on the web pages.

### BACKGROUND OF THE INVENTION

Almost all the organizations have websites nowadays. Those organizations have invested significant amount of resources to create, update and maintain their websites. A website's success depends on several important parameters, such as the traffic and the amount of time spent by a visitor on the website. Therefore, most of the organizations investigate the traffic and the time spent by the visitors on their websites to determine their websites' success. Thus, a marketing campaign that results in high traffic and causes individual visitors to spend a significant amount of time on the website is considered successful, and as a result, helps to increase revenue of the organization. In-addition to driving incremental (new) revenue to the business and delivering a measurable “return on their investment”, websites have been reduced to a new “cost of doing business” for many organizations.

Most organization websites provide extensive product “information” and often contain brand building and customer service features (e.g., how to contact us, free recipes, etc.). But, with the exception of a few websites who effectively market themselves via the web (e.g., Amazon, EBay), only a very few websites actually generate substantive new revenues for their owners, and after taking the cost of web operations into account, even fewer websites are actually profitable. In fact, most websites actually suffers financial loss.

Generally, new and old visitors are directed to the website from different sources/channels (e.g. emails, search engines, referral websites, display, etc.). How visitors navigate the website and respond to the web page depends upon the interaction of the web page layout, link structure, design elements, content and marketing stimuli on the web page with the needs of the visitors. Hence it is desirable for the website owners to discover a model for the navigation process to analyze how visitors are responding to the website to satisfy their needs/intents.

Despite the enormous advancement in the online business technology, there is a need analysis tool, particularly in the manner of effective website development and website navigation path analysis. Path analysis basically analyzes how a visitor or user of a website navigates the actual path of a website and reaches to the endpoint of website as per the need and the elements of the web pages.

Further, there is a need to develop a model for statistical analysis about navigation between web pages. It is also required to develop a relationship between the user needs and the web page elements for effectively holding the user's attention.

Hence, in the light of above discussion, it is desirable to develop a method and a system for website navigation analysis that can fulfill one or more aforementioned requirements.

### SUMMARY OF INVENTION

One aspect of the present invention is a method of website navigation path analysis. A website comprises of a plurality of web pages on the website. A source web page is a web page where a user clicks on a link and then the link takes him/her another web page which is the destination web page. method of website navigation path analysis comprises: categorizing web pages of the website into one or more groups/categories of web pages based on the domain knowledge and functional similarities between the web pages; calculating an index score for each web page category for being the entry web page; calculating a casual score by analyzing user movement from one web page category to another; calculating a baseline score for each pair of the source and destination web page categories; calculating incremental lift of the causal scores from the baseline scores for each pair of the source and the destination web page categories; combining the source and the destination webpage pair and calculating engagement scores for each web page pair of the source and the destination web page categories to measure the ability of the web page to hold user's attention; overlaying the engagement scores for each pair of the source and the destination web page to determine which web pages and transitions correspond to engagement and decision making.

Another aspect of the present invention is a method that further comprises training a statistical model with the learned causal score and weights calculated from the engagement score to get a discovered model of the path structure drawing up the desired model of the path analysis and compare it with a discovered model of the path analysis, and identifying drivers and barriers for the desired model.

Another aspect of the present invention is a system for website navigation process comprising: a processor; a non-transitory computer-readable storage medium coupled to the processor, wherein the processor executes plurality of the modules/subsystems stored in the storage medium, and wherein the plurality of modules/subsystems are a data categorizing module for categorizing web pages of the website into one or more groups/categories of web pages based on the domain knowledge and functional similarities between the web pages; a score assigning module for calculating an index score, casual score, base line score and engagement score for web page elements and categorized web page pair; statistical model to be trained with the scores and weight calculated by the score assigning module, and analyzing module for determining which web pages and transitions correspond to engagement and decision making based on the trained statistical model.

Another aspect of the present invention is a computer program product website navigation path analysis, the website navigation consisting of a source web page and a destination web page, the computer program product comprising: at least one non-transitory computer-readable storage medium having computer-readable program code portions stored therein, said computer-readable program code portions comprising instructions for performing the aforementioned method.

Some or all of the aforementioned advantages of the invention are accrued in case of the phenomena where a sequence of events are taking place and a discovered model is required to be generated based on the underlying website navigation path analysis. The discovered model can be used to compare against the desired a-priori model of the process. This can be particularly useful in conformance checking, performance evaluation and identifying steps for the improvements in the website design.

This invention is pointed out with particularity to the appended claims. Additional features and advantages of the system will become apparent to those skilled in the art by referring to the following detailed description taken in conjunction with the accompanying drawings.

### BRIEF DESCRIPTION OF DRAWINGS

The features of the present invention, which are believed to be novel, are set forth with particularity in the appended claims. The invention may be best understood by reference to the following description, taken in conjunction with the accompanying figures. These figures and the associated description are provided to illustrate some embodiments of the invention, and not to limit the scope of the invention. In the following the invention will be described in greater detail with reference to exemplary embodiments in accordance with the accompanying drawings, in which:

FIG. 1 demonstrates a flow diagram depicting the website navigation path analysis in accordance with an embodiment of the present invention;

FIG. 2 demonstrates an embodiment for calculating the casual score in accordance with another embodiment of the present invention;

FIG. 3 demonstrates an embodiment for calculating the baseline score in accordance with another embodiment of the present invention;

FIG. 4 demonstrates an embodiment for calculating the incremental lift score in accordance with another embodiment of the present invention;

FIG. 5 demonstrates an embodiment for designed or discovered model in accordance with another embodiment of the present invention;

FIG. 6 demonstrates an example of learned Bayesian Belief Network using design model as the input in accordance with another embodiment of the present invention;

FIG. 7 demonstrates an example of the conclusion derived from the Bayesian Belief Network in accordance with another embodiment of the present invention;

FIG. 8 demonstrates a system for website navigation path analysis in accordance with another embodiment of the present invention.

The features of the invention illustrated above and below in the specification, are described with reference to the drawings summarized above. The reference numbers shown in the drawings may be used at one or more places to indicate the functional relation between the referenced elements. Some of the embodiments are described in the dependent claims.

### DETAILED DESCRIPTION OF THE INVENTION

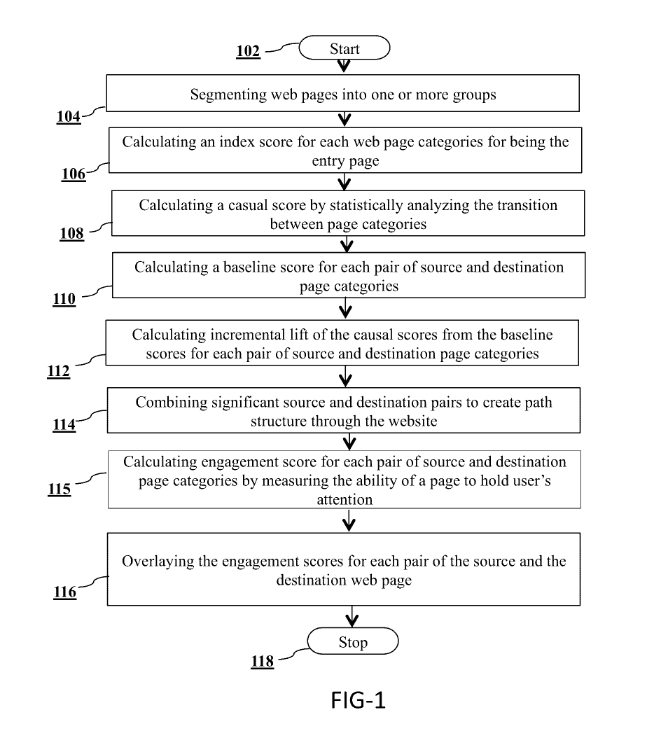

The following detailed description is merely exemplary in nature and is to enable any person skilled in the art to make and use the invention. The examples shown in description are not intended to limit the application and uses of the various embodiments. Various modifications to the disclosed invention will be readily apparent to those skilled in the art, and the methodology defined herein may be applied to other embodiments and applications without departing from the spirit and the scope of the present disclosure. Thus, the present invention is not limited to the examples discussed below, but is to be accorded the widest scope consistent with the methodology and features disclosed herein. It should also be noted that FIGS. 1-8 are merely illustrative and may not be drawn to scale.

The foregoing objects of the present invention are accomplished and the problems and shortcomings associated with the prior art, techniques and approaches are overcome by the present invention, as described below in the preferred embodiments.

The exemplary methods described below are typically stored on a computer-readable storage medium, which may be any device that can store code for use by a computer system, mobile and others. The computer-readable storage medium includes, but is not limited to volatile memory, non-volatile memory, magnetic and optical storage devices such as disk drives, magnetic tape, CDs (compact discs), DVDs (digital versatile discs or digital video discs), or other media capable of storing code now known or later developed.

Furthermore, methods described herein can be embossed on hardware modules or apparati. These modules or device may include, but are not limited to, an application-specific integrated circuit (ASIC) chip, a field-programmable gate array (FPGA), a dedicated or shared processor that executes a particular software module or a piece of code at a particular time, and/or other programmable-logic devices known or later developed. When the hardware modules or apparatus are activated, they perform the methods and processes included within them.

The terms “a” or “an”, as used herein, are defined as one or more than one. The term “another”, as used herein, is defined as at least a second or more. The terms “including” and/or “having”, as used herein, are defined as comprising (i.e. open transition).

Referring to FIG. 1, an embodiment of the present invention discloses a method 100 of website navigation path analysis. The website comprises of a plurality of web pages on the website. A source web page is a web page where a user clicks on a link and then the link takes him/her another web page which is the destination web page. The method 100 initiates at step 102. In step 104, the web pages of the website are categorizes into one or more groups of web pages based on the domain knowledge and functional similarities between the web pages.

Further, in step 106 an index score is calculated for each web page category for being the entry web page. The index score is calculated for each category of the web page clicked or selected by the user.

In step 108, a casual score is calculated by statistically analyzing the transition between web page categories. The casual score is calculated for measuring the extent to which the source web page elements cause the visitor to go from the source web page to the destination web page. The web page elements (source and destination web page elements) may include one or more elements such as web page layout/design, link structure, content, call to actions and other marketing elements.

In step 110, a baseline score is calculated for each pair of the source and destination web page categories.

Further, in step 112, an incremental lift score is calculated from the causal scores from the baseline scores for each pair of the source and the destination web page categories. The incremental lift score is a measure of whether the movement is being caused by the element of the web pages.

Afterward, in step 114, the source and the destination web page pairs are combined to create a path structure through the websites.

In step 115, for each pair of source and destination web page engagement score has been calculated by measuring the ability of a web page to hold user's attention.

Further, in step 116 the engagement scores for each pair of the sources and the destination web pages are overlaid to determine which web pages and transitions correspond to engagement and decision making.

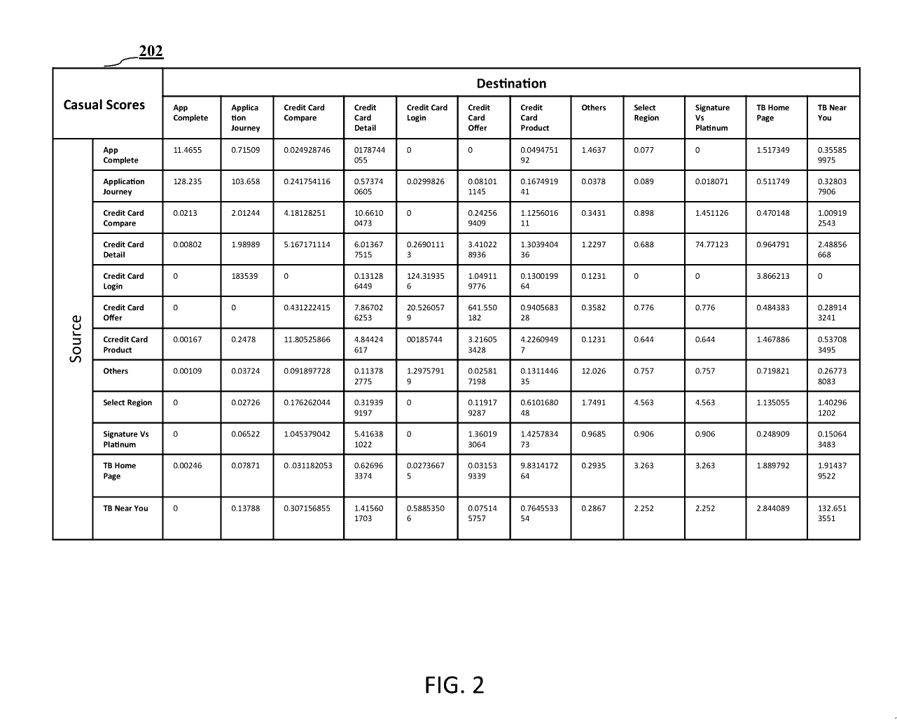

Referring to FIG. 2 of the present invention, the casual score 202 is calculated for the plurality of the web page elements. The figure depicts the score assigned in proportion with the number of users navigated to the plurality of destination web pages from the source web pages. In an embodiment of the present invention, the scores can be any positive integer. In another embodiment of the present invention, the score can be the probabilistic numerals.

As shown in figure, the score against each field of source to destination states the probability of user to navigate the particular web page associated with the mentioned element.

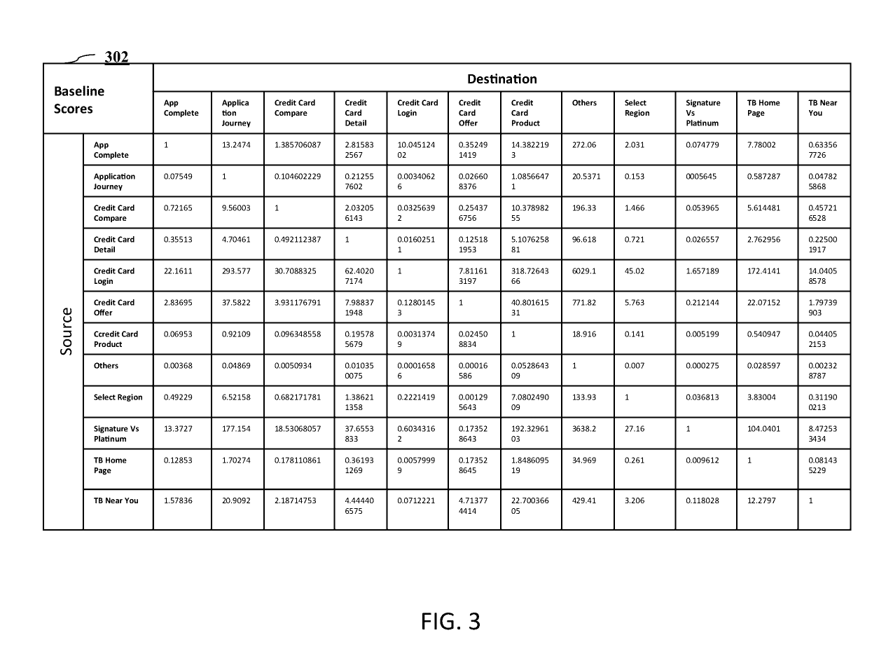

In an exemplary embodiment, as depicted in the figure, number 11.4655 proportionate users have started navigating the website from the “App complete” web page. Similarly, number 128.235 proportionate users have started from “application” journey web page and no user has started from the webpages of “credit card login” and “credit card offer”. Further, it shows that 0.355859975 proportionate users from the 11.4655 proportionate users have ended the website navigation at TB near you web page. Referring to FIG. 3, in an embodiment of the present invention, the baseline score 302 is calculated for the plurality of the web page categories. The figure depicts the score before the starting of navigation by the users to the plurality of destination web pages from the source web pages.

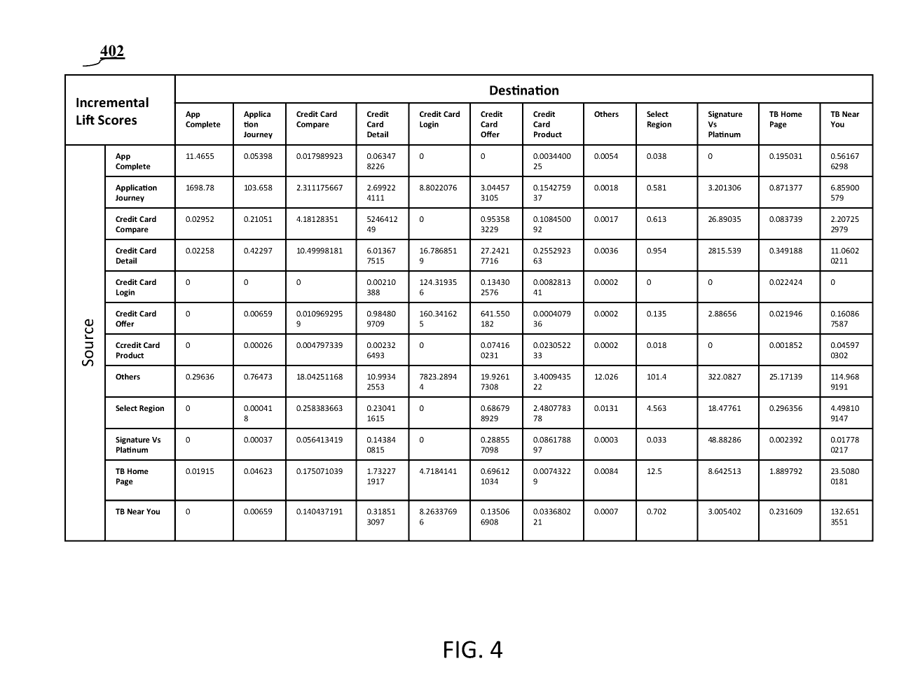

Referring to FIG. 4, in an embodiment of the present invention, the incremental lift score 402 is calculated for the plurality of the web page categories. The figure depicts the uplift score from the baseline score after the number of users navigated to the plurality of destination web pages from the source web pages.

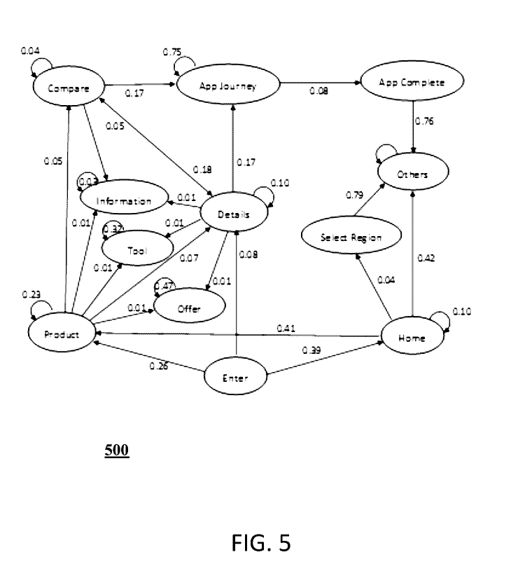

Referring to FIG. 5, in an embodiment of the present invention, the discovered model of the path analysis 500. The statistical model predicts the user's intent before the user leaves the website. In another embodiment of the present invention, one or more statistical models for example, a combination of a Naive Bayes Classifier and a Markov model can be used. In other embodiments of the present invention, structural model may be utilized for the predicting the user intent.

In a further embodiment of the present invention, the statistical model is trained with the learned causal score and weights calculated from the engagement score to get a discovered model of the path analysis. Further the drivers and barriers identified for the desired model. The drivers and barriers such as link design, content of the web page, URL density, font, offers etc. are further refined to improve the transition between web pages of the website.

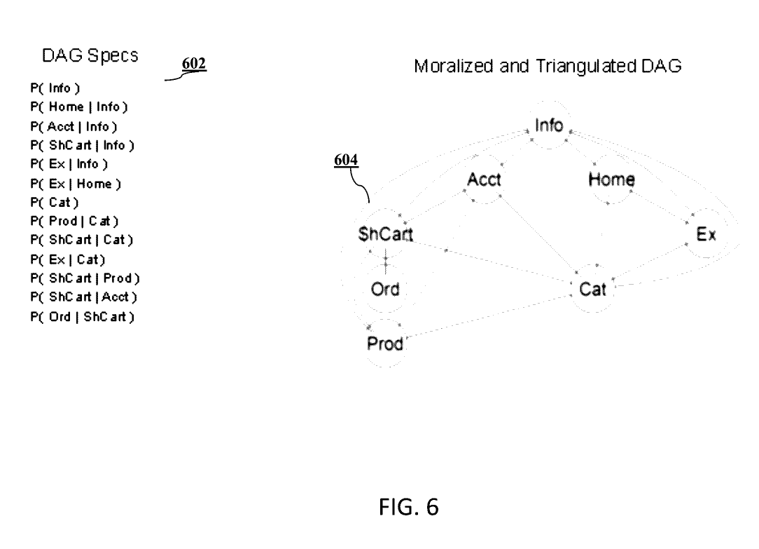

As depicted in FIG. 6, in an embodiment of the present invention, the statistical model is an example of Bayesian Belief Network (probabilistic model) using design model as the input. In an embodiment of the present invention, the engagement score is assigned to analyze the time of user engagement with the particular elements of the webpage. The discovered model of the path analysis as shown in FIG. 5 is based on the training data calculated from the weight of scores. For interference, the original directed acyclic graph 602 is converted into an undirected equivalent version (through moralization and triangulation) to capture dependencies.

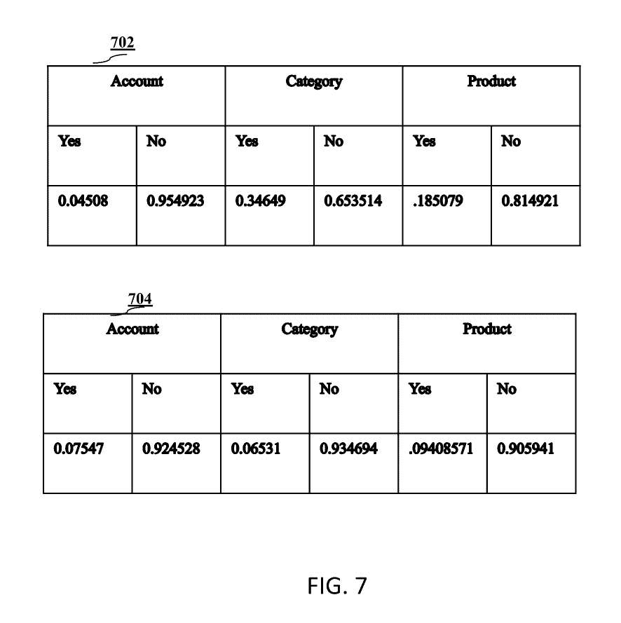

Referring to FIG. 7, in the embodiment of the present invention, the probabilities of the account, category and product page 702 are shown according to the example of the conclusion derived from Bayesian Belief network as shown in FIG. 6. In the embodiment of the invention, the user visit information is tracked and it is determined that whether the user placed the order or not by the 704. The change in probability is further determined to check the number of user and to draw visit and purchase inference.

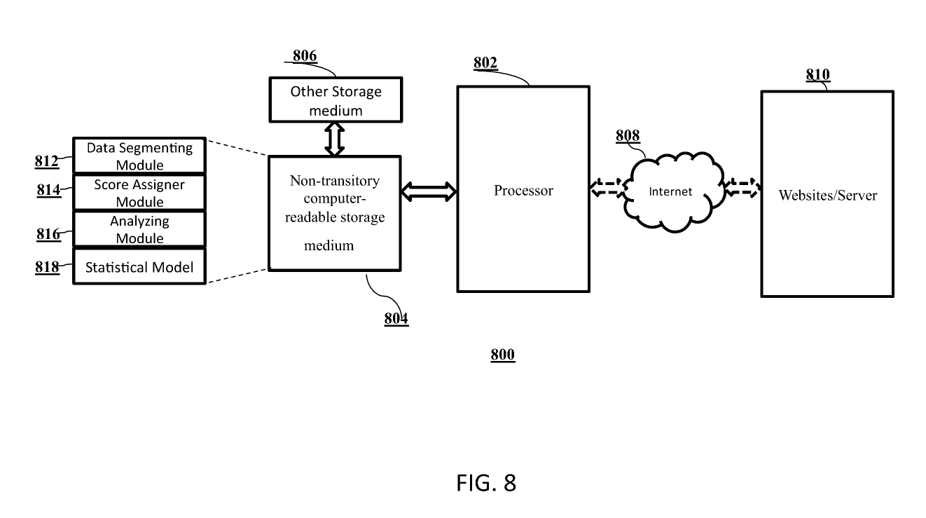

Referring to FIG. 8, in an embodiment of the present invention, a system 800 for website navigation path analysis is shown. The system 800 comprises a processor 802 and a non-transitory computer-readable storage medium 804 coupled to the processor 802. The processor 802 executes plurality of the modules/subsystems stored in the storage medium 804.

The plurality of modules/subsystems are a data categorizing module 812 for categorizing web pages of the website into one or more groups/categories of web pages based on the domain knowledge and functional similarities between the web pages; a score assigning module 814 for calculating an index score, casual score, base line score and engagement score for web page elements and categorized web page pair; a statistical model 818 to be trained with the scores and weight calculated by the score assigning module, and an analyzing module 816 for determining which web pages and transitions correspond to engagement and decision making based on the trained statistical model.

In another embodiment of the present invention, a computer program product website navigation path analysis, the website navigation comprising of a source web page and a destination web page, the computer program product comprising: at least one non-transitory computer-readable storage medium having computer-readable program code portions stored therein, said computer-readable program code portions comprising instructions for performing the aforementioned method.

In an embodiment of the present invention, some or all of the aforementioned advantages of the invention are accrued in case of the phenomena where a sequence of events are taking place and a discovered model is required to be generated based on the underlying website navigation path analysis. The discovered model can be used to compare against the desired a-priori model of the process. This can be particularly useful in conformance checking, performance evaluation and identifying steps for the improvements in the website design.

In another embodiment of the present invention, the system 800 is enabled to complete the website navigation path analysis and to automatically optimize the website as per the results obtain from the analysis. Various algorithms can be deployed for the automatic website optimization or recommendations.

Though exemplary embodiments have been presented in the foregoing detailed description of the invention, it should be appreciated that a vast number of variations exist. It should also be noted that the disclosed embodiments and methods are not intended to limit the scope and applicability of the invention in any way. Rather, the foregoing detailed description will provide those skilled in the art with a convenient road map for implementing an exemplary embodiment of the invention, with it being understood that various changes may be made in the methods and order of steps described in an exemplary embodiment without departing from the scope of the invention as set forth in the appended claims and their legal equivalents.

1. A method of website navigation path analysis, wherein the website navigation comprises a source web page and a destination web page, the method of website navigation path analysis comprising:
a. categorizing web pages of the website into one or more groups of web pages based on the domain knowledge and functional similes between the web pages;
b. calculating an index score for each web page categories for being the entry web page;
c. calculating a casual score by analyzing user movement from one web page category to another;
d. calculating a baseline score for each pair of the source and destination web page categories;
e. calculating incremental lift of the causal scores from the baseline scores for each pair of the source and the destination web page categories;
f. combining the significant source and the destination webpage pairs into a path structure; and
g. calculating engagement scores for each web page pair of the source and the destination web page categories to measure the ability of the web page to hold user's attention;
overlaying the engagement scores for each pair of the source and the destination web page to determine which web pages and transitions correspond to engagement and decision making.

2. The method as claimed in claim 1 further comprising:
training a probabilistic network model for drawing inference from the path structure;
comparing path structure with a discovered model of the path analysis, and
identifying drivers and barriers for the desired model.

3. The method as claimed in claim 1, wherein the casual score is calculated by analyzing the user movements between the web page categories of the website.

4. The method as claimed in claim 1 further comprising filtering the in-coming traffic with different criteria, such as sources/channels, user-categories, devices etc.

5. The method as claimed in claim 1 further comprising using of total traffic as well as filtered traffic for website navigation process analysis.

6. The method as claimed in claim 1, wherein the statistical model is used to create or design the path structure.

7. The method as claimed in claim 1, wherein the statistical model is a trained probabilistic model which is used to draw inferences from the designed process.

8. The method as claimed in claim 1, wherein the website navigation also comprises intermediate movements between the web pages of the website.

9. The method as claim in claim 1, wherein the web page elements include one or more of a web page layout/design, link structure, content, call to actions and other marketing elements.

10. The method as claimed in claim 1 further comprising recommending a set of data to a website designer about site design, site structure, web page design, web page contents and elements related to messaging, positioning and call to actions.

11. A system for website navigation path analysis comprising:
a. a processor;
b. a non-transitory computer-readable storage medium coupled to the processor, wherein the processor executes plurality of the modules/subsystems stored in the storage medium, and wherein the plurality of modules/subsystems are:
i. a data categorizing module for categorizing web pages of the website into one or more groups of web pages based on the domain knowledge and functional similarities between the web pages;
ii. a score assigning module for calculating an index score, casual score, base line score and engagement score for web page elements and categorized web page pair;
iii. a statistical model to be trained with the scores and weight calculated by the score assigning module, and
iv. an analyzing module for determining which web pages and transitions correspond to engagement and decision making based on the trained statistical model.

12. A computer program product website navigation path analysis, the website navigation comprises of a source web page and a destination web page, the computer program product comprising: at least one non-transitory computer-readable storage medium having computer-readable program code portions stored therein, said computer-readable program code portions comprising instructions:
a. categorizing web pages of the website into one or more groups of web pages based on the domain knowledge and functional similarities between the web pages;
b. calculating an index score for each web page category for being the entry web page;
c. calculating a casual score by analyzing user movement from one web page category to another;
d. calculating a baseline score for each pair of the source and destination web page categories;
e. calculating incremental lift of the causal scores from the baseline scores for each pair of the source and the destination web page categories;
f. combining the source and the destination web page pairs into a path structure; and
g. calculating engagement scores for each web page pair of the source and the destination web page categories to measure the ability of the web page to hold user's attention;
overlaying the engagement scores for each pair of the source and the destination web page to determine which web pages and transitions correspond to engagement and decision making.
